(19) United States
(12) Patent Application Publication
(10) Pub. No.: US 2009/0296240 A1
(43) Pub. Date: Dec. 3, 2009

(54) Temperature compensation of optical systems

(76) Inventor: Gerald Franz, Backnang (DE)

Correspondence Address: KENYON & KENYON LLP, ONE BROADWAY, NEW YORK, NY, 10004, US

(21) Appl. No.: 11/990,874

(22) PCT Filed: Jul. 21, 2006
(86) PCT No.: PCT/EP2006/064538

§ 371 Date: Jul. 13, 2009

(30) Foreign Application Priority Data
Aug. 22, 2005 (DE) 10 2005 039 561.9

(51) Int. Cl. G02B 7/00

(52) U.S. Cl. 359/820

(57) ABSTRACT

An optical system, in particular for use in the automobile sector, includes at least one compensation element for compensating at least one temperature-related dimension change in the optical system. The at least one compensation element includes a housing which is variable in length in at least one dimension, as well as a fluid expansion medium accommodated in the at least one housing. For example, the optical system may include at least one camera system, for example a video system, the at least one camera system including at least one camera base and at least one imaging system which is connected to the at least one camera base and having at least one optical axis as well as at least one imaging sensor.

### FIELD OF THE INVENTION

The present invention relates to an optical system having temperature compensation via at least one compensation element. Optical systems of this type may be used, for example, in the form of camera systems, in particular in the automobile sector.

### BACKGROUND INFORMATION

Optical systems are being used to an increasing extent in the automobile sector. Examples include the use of different camera systems to monitor interior and/or exterior areas as well as distance sensors or visibility systems.

However, optical systems, for example fixed-focus video applications, are subject to extreme temperature requirements in automobiles. Typical temperature ranges within which the systems must operate without errors lie between −40° C. and 120° C. Due to these extreme temperature ranges, the mechanical and/or optical components contained in these optical systems often undergo substantial dimension changes. In particular, lens seats as well as optical components such as lenses or filters may undergo a change in length and/or an increase in diameter. In the case of imaging optical components, for example, distances between individual lenses and an imaging sensor frequently change. As a result, the imaging characteristic of these systems also changes, which is noticeable in particular in the case of objectives of short focal length having a high numeric aperture. Above all, the focusing status of the system changes. In addition, the imaging performance will also decrease, which is attributable, for example, to an increase in aberrations (in particular, spherical aberrations and/or comas).

Optical systems which are intended to prevent such dimension changes in optical systems due to temperature fluctuations are therefore known from the related art. German patent document DE 102 61 973 A1 discusses an optical system for a camera which includes at least one lens, one image sensor, and one tube. The lens and the tube accommodating the lens and image sensor are made of plastic, and the image sensor is situated in the focal plane of the lens. Material which has a coefficient of thermal expansion adjusted to the lens material is provided at least for a partial area of the tube in such a way that a change in the lens focal length due to temperature changes is compensated by a thermal variation in the length of the tube, such that the image sensor accommodated by the tube is always situated at least approximately in the focal plane within a certain temperature range.

A temperature compensator is discussed in JP 58-7109A, which is used to compensate temperature-related displacements of the image plane in video cameras having plastic lenses. An imaging sensor is connected to a lens holder via a plastic material which has a thickness equal to the focal length of the lens system. This makes it possible to compensate a displacement of the image plane caused by temperature fluctuations.

However, the systems known from the related art have a number of disadvantages in practice. In particular, selecting suitable materials as well as dimensioning the systems accordingly place high demands on the structural design. For example, if the structure of the optical system changes, due to a design change, the dimensioning of the compensation elements must also be adjusted directly. This usually requires changing the mechanical dimensioning and/or changing the materials of the compensation elements, which in many cases makes it necessary to completely redesign the optical systems.

Furthermore, the known systems often have highly complex construction, which makes them complicated and expensive. Systems of this type thus often have folded ray paths and/or stacked or overlapping compensation elements, as discussed, for example, in DE 102 61 973 A1.

A further disadvantage lies in the fact that the known temperature compensation systems frequently have mechanical stresses within extreme ranges in the case of the aforementioned temperature changes, for example at the transition between the individual temperature compensation elements. These mechanical stresses may, on the one hand, result in damage to the components or systems. On the other hand, however, these stresses, in turn, contribute to the impairment of optical characteristics, since, for example, stresses may decrease abruptly, producing spontaneous and unpredictable changes in the imaging characteristics of the optical systems.

### SUMMARY OF THE INVENTION

An optical system is therefore provided which partially or entirely avoids the disadvantages of the above-described systems known from the related art. The optical system is thus suitable, in particular, for use in the automobile sector, but may also be used in all other fields of science and technology. An “optical system” may be understood to be any system in which information (for example, in the form of images, light signals, or the like) is to be collected and/or transmitted through an optical arrangement, i.e., utilizing electromagnetic waves in the visible, ultraviolet, or infrared spectral range. Examples of such systems are camera systems, for example video camera systems. Optical systems are also understood to be subsystems, for example, lens systems which are combined to form one or more objectives or other imaging systems.

A basic idea of the exemplary embodiments and/or exemplary methods of the present invention is to use at least one compensation element for compensating at least one temperature-related dimension change of the optical system, which may result, in particular, in a change in reproduction and/or imaging characteristics. In contrast to other systems, however, this at least one compensation element according to the present invention includes at least one housing which is variable in length in at least one dimension, as well as at least one fluid expansion medium accommodated in the at least one housing.

The length-variable characteristic of the at least one housing is achievable according to the present invention in different ways. For example, the length-variable housing may have a telescopic length-variable housing part. Alternatively or in addition, the length-variable housing may be made partially or entirely of plastic materials, for example elastomers or thermoplastics, and may have flexible and/or plastic characteristics in at least one dimension. Flexible characteristics may be better, since they guarantee that the thermal variation in housing length is reversible. In an exemplary embodiment, the length-variable characteristics of the at least one housing are produced in at least one dimension by using a corrugated hose, for example a corrugated hose or corrugated bellows made of metallic materials and/or plastic materials.

The at least one length-variable housing may also include at least two plane-parallel end faces. In this case, it is advantageous if the housing is variable in length in a direction perpendicular to these plane-parallel end faces. This embodiment of the present invention ensures that the thermal compensation takes place perpendicularly to the plane-parallel end faces, in particular defined in this direction. A tilting of the plane-parallel end faces toward one another as a result of thermal variations in length is thus largely avoidable.

According to the present invention, the provided optical system offers a great deal of flexibility in selecting the fluid expansion medium. A “fluid expansion medium” may be understood to be a liquid or a gas, a liquid may be used according to the present invention. This liquid may be filled in a bubble-free manner into the at least one length-variable housing in such a way that the at least one length-variable housing encloses the liquid without leakage.

Alternatively, one or more liquids may be used as an individual liquid or a liquid mixture. In particular, water, alcohol (in particular ethanol) as well as a mixture of these liquids have proven to be particularly suitable in practice. However, other liquids or liquid mixtures, such as mixtures of polar and nonpolar liquids, may also be used. In particular, the thermal expansion characteristics of the fluid expansion medium (in particular of a liquid mixture) are precisely settable by setting mixture ratios. In particular, it is advantageous if the at least one fluid expansion medium has a higher coefficient of thermal expansion, in particular a higher coefficient of volumetric thermal expansion, than the other materials used in the optical system, in particular those materials which are used, for example, to secure optical components and/or to space optical components (for example, lenses) with respect to corresponding imaging systems (for example, CCD chips). This ensures that a compensation of thermally produced length variations in, for example, large objective mounts or the like in optical systems is achievable even when using low-volume compensation elements.

The optical system may also have at least one temperature regulating element which is designed to set at least one temperature of the at least one fluid expansion medium and/or regulate at least one temperature of the at least one fluid expansion medium. For example, the at least one temperature regulating element may have at least one heating element (e.g., a heating resistor) via which the fluid expansion medium is heatable. The medium may also be heated, for example, in a regulated manner, e.g., using a simple thermostat. In addition to a simple heating element, a cooling element, for example, or a heating/cooling element may be used, for example a Peltier element. As a result, the temperature of the fluid expansion medium may be set selectively and largely independently of the ambient temperature to compensate a temperature-related dimension change in the optical system. A selective, active refocusing function is provided in this manner.

In particular, an optical system is provided according to the present invention, which has at least one camera system. This at least one camera system should include at least one camera base and at least one imaging system which is connected to the at least one camera base and has at least one optical axis. In particular, this at least one imaging system may include an objective. The camera system according to the present invention should also have at least one imaging sensor, for example a CCD chip.

The at least one camera system may be designed, for example, in such a way that the at least one imaging sensor is connected to the at least one camera base via the at least one compensation element. In particular, the compensation element may be equipped with two plane-parallel faces, as described above, which may be situated perpendicularly to the at least one optical axis. The at least one length-variable housing of the at least one compensation element should be variable in length parallel to the optical axis.

According to the exemplary embodiments and/or exemplary methods of the present invention, therefore, the compensation element is used to move the at least one imaging sensor in relation to the imaging system, in particular the objective, in such a way that the temperature-related defocusing is equalized again by the at least one compensation element. Alternatively or in addition, in a manner similar to the embodiment in DE 102 61 973 A1, the imaging system may also be connected to at least one compensation element in such a way that the imaging system is moved relative to the imaging sensor to equalize the temperature-related defocusing.

The optical system according to the present invention in one of the embodiments described has numerous advantages over the related art. These advantages are due, in particular, to the use of the fluid expansion medium. This use provides a practical design flexibility, since it is possible to adjust the length extension of the compensation element without changing the design of the optical system, for example by adding suitable liquids or liquid mixtures. In contrast to the systems described in the related art, a design change, for example by using a new imaging system (for example, an objective), thus does not necessarily mean completely restructuring the optical system, in particular the camera, for the purpose of temperature compensation. Instead, according to the exemplary embodiments and/or exemplary methods of the present invention, the fluid expansion medium may be simply replaced by an alternative, adapted fluid expansion medium.

A further advantage lies in the fact that fluid expansion media do not build up inner stresses, in contrast to solid material. As a result, there is no undesirable, uneven length extension of the compensation element, which, in the case of the systems known from the related art, may result in, for example, twisting or inclination (tilting) of the optical systems. In addition, convective heat conduction produces thermal equilibrium more quickly in a compensation element filled with a fluid expansion medium than in a solid body. The optical system according to the present invention therefore responds more quickly to temperature changes than do corresponding conventional systems.

Moreover, in the systems according to the present invention, it is not necessary to produce folded ray paths or a stacked temperature compensation, which—as described above—makes the temperature compensation systems known from the related art impractical and expensive. The optical system according to the present invention is therefore easy to design structurally and is therefore economical and easy to mount. However, optical systems may also be produced in which a compensation element provided according to the present invention is combined with a fluid expansion medium having “conventional” compensation elements, in particular solid compensation elements.

The exemplary embodiments and/or exemplary methods of the present invention is described in greater detail below on the basis of the drawing.

### BRIEF DESCRIPTION OF THE DRAWING

The FIGURE shows a schematic diagram of an exemplary embodiment of a temperature-compensated optical system in the form of a camera system.

### DETAILED DESCRIPTION

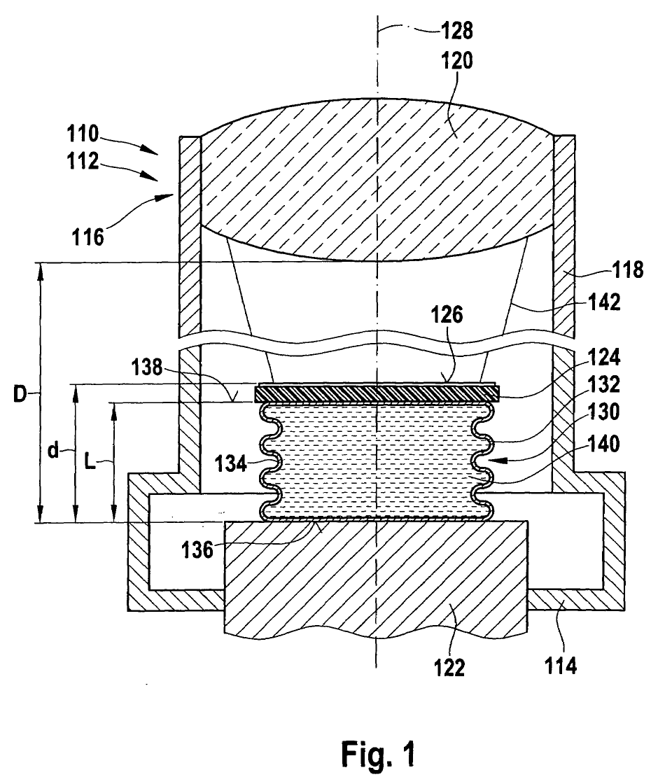

The single FIGURE (FIG. 1) shows a schematic diagram of an exemplary embodiment according to the present invention of an optical system 110 in the form of a camera system 112. The camera system includes a camera housing 114, it being possible to also use unencapsulated camera systems 112 as an alternative, i.e., camera systems 112 which do not include a camera housing 114.

Camera system 112 includes an imaging system 116 in the form of an objective. This imaging system 116 is represented only symbolically in FIG. 1 and includes an objective housing 118 and a lens system 120. Of lens system 120, only the last lens which faces camera housing 114 is illustrated. However, even more complex lens systems may be provided as well as other optical components, for example combinations of lenses and filters. Lens system 120 is usually permanently connected to objective housing 118.

Camera system 112 also includes a camera base 122 accommodated in camera housing 114. This camera base 122 may include, for example, a base plate, or it may be part of camera housing 114 or it may include a printed circuit board accommodated in camera housing 114.

The camera base accommodates an imaging sensor 124, the image-sensitive surface 126 of which faces lens system 120. Image-sensitive surface 126 of imaging sensor 124 is situated, in principle, perpendicular to an optical axis 128 of imaging system 116. Depending on the application, certain deviations from the perpendicular are tolerable, for example deviations of no more than 30.

A compensation element 130, which connects imaging sensor 124 and camera base 122, is situated between imaging sensor 124 and camera base 122. This compensation element 130 includes a housing 132. This housing 132 has a side wall parallel to optical axis 128 in the form of a corrugated hose 134. This corrugated hose 134 may be made, for example, of stainless steel, copper, or brass or of other suitable solid materials. Housing 132 also has two plane-parallel end faces 136, 138 which are oriented perpendicularly to optical axis 128. These plane-parallel end faces 136, 138 hermetically seal corrugated hose 134 on the bottom and top, respectively (i.e., in particular, liquid- or gas-tight), for example by soldering them to corrugated hose 134.

A fluid expansion medium 140 is introduced into housing 132, this medium being a liquid which is inert to housing 132 in the present exemplary embodiment. In addition to pure materials, mixtures of different liquids are particularly suitable, for example an ethanol-water mixture.

Imaging system 116 forms an image of an object on image-sensitive surface 126 of imaging sensor 124. In FIG. 1, this image is represented symbolically by reference numeral 142. For example, image-sensitive surface 126 is positioned in such a way that it is situated in the image plane (focal plane in the case of an infinite object distance) of imaging system 116 to produce a sharp image of an object.

As a result of temperature differences, however, the dimensioning of camera housing 114 and imaging system 116 is not rigid. Instead, objective housing 118 and camera housing 114 expand, for example as a result of a temperature increase. The optical characteristics and/or dimensioning of lens system 120 is/are also variable. As a result, distance D between camera base 122 and lens system 120 is dependent on the temperature. D changes in the case of a temperature-related expansion. Therefore, if there is no temperature compensation, the image plane of lens system 120 would thus lie above image-sensitive surface 126 in the case of such a temperature increase, which would result in a reduced image quality (for example, a fuzzy image).

However, compensation element 130 is designed in such a way that fluid expansion medium 140 also expands according to its coefficient of volumetric expansion when temperature changes occur. Length L of corrugated hose 134 will change accordingly, due to the flexibility of corrugated hose 134. If the temperature increases, compensation element 130 therefore expands in such a way that the distance between camera base 122 and image-sensitive surface 126 also increases.

If fluid expansion medium 140 is suitably selected and housing 132 is suitably dimensioned, an increase in distance D may be temperature-compensated by adjusting distance d accordingly. Ordinarily, this temperature compensation is not fully achieved for all possible temperatures. However, by selecting a suitable fluid expansion medium 140, for example by setting an appropriate ethanol-water mixing ratio, the temperature compensation may be designed in such a way that the defocusing of the optical system is equalized again for a certain temperature change. This means that d is increased by the same absolute value (compared to a reference temperature) as D. Entire optical system 110 will therefore be correctly focused at least at this elevated temperature and at the reference temperature (which may be, for example, room temperature), i.e., at two temperatures, with the result that imaging system 116 correctly forms an image of an object on image-sensitive surface 126.

1-10. (canceled)

11. An optical system, comprising:
an optical arrangement; and
at least one compensation element to compensate at least one temperature-related dimension change of the optical arrangement, wherein the at least one compensation element includes at least one housing which is variable in length in at least one dimension, and wherein at least one fluid expansion medium is in the at least one housing.

12. The optical system of claim 11, wherein the optical arrangement includes at least one camera system having at least one camera base and at least one imaging system which is connected to the at least one camera base and having at least one optical axis, and at least one imaging sensor.

13. The optical system of claim 12, wherein the at least one imaging sensor is connected to the at least one camera base via the at least one compensation element, the at least one length-variable housing of the at least one compensation element being variable in length parallel to the optical axis.

14. The optical system of claim 11, wherein the at least one length-variable housing has at least one of flexible characteristics and plastic characteristics in one dimension.

15. The optical system of claim 11, wherein the at least one housing includes at least two plane-parallel end faces.

16. The optical system of claim 15, wherein the housing is variable in length in a direction perpendicular to the plane-parallel end faces.

17. The optical system of claim 11, wherein the at least one length-variable housing includes at least one corrugated hose.

18. The optical system of claim 11, wherein the at least one fluid expansion medium has a liquid.

19. The optical system of claim 18, wherein the expansion medium has at least one of water, an alcohol, and an ethanol.

20. The optical system of claim 11, further comprising: at least one temperature regulating element for regulating at least one temperature of the at least one fluid expansion medium.

21. The optical system of claim 11, wherein the optical system is for a motor vehicle.

22. The optical system of claim 11, wherein the optical arrangement includes at least one camera system having at least one camera base and at least one imaging system which is connected to the at least one camera base and having at least one optical axis, which is an objective, and at least one imaging sensor.
